(19) United States
(12) Patent Application Publication
(10) Pub. No.: US 2018/0308108 A1
(43) Pub. Date: Oct. 25, 2018

(54) SYSTEM AND METHOD FOR GATHERING, STORING, AND CORRELATING DATA ABOUT INDIVIDUALS ACROSS A PLURALITY OF COMMUNICATIONS NETWORKS

(71) Applicant: Kenneth Shigeru, Miami, FL (US)

(72) Inventor: Kenneth Shigeru, Miami, FL (US)

(21) Appl. No.: 15/483,024

(22) Filed: Apr. 22, 2017

(51) Int. Cl. G06Q 30/02; H04W 4/02; H04W 8/18; G06Q 30/08

(52) U.S. Cl. CPC G06Q 30/0201; G06Q 30/08; H04W 8/18; H04W 4/028

(57) ABSTRACT

A system and method are provided for correlating data regarding a plurality of subscribers, the system and method gathering data from each of the plurality of subscribers regarding a first subject matter via a first communications system, processing the gathered data from each of the subscribers, correlating substantially similar gathered data from each of the subscribers into separate respective correlated data reports, and reporting one or more of the separate respective reports to one or more third parties via a second communications system.

### TECHNICAL FIELD

The embodiments described herein relate generally to computer networks and systems, methods, and modes for gathering, storing, and correlating data about individuals across a plurality of communications networks.

### BACKGROUND

It is very well understood by most people today that the use of the Internet is nearly ubiquitous in industrial nations, and rising in all other parts of the world. Some sources place the connectivity of the entire population of the globe at about 40% (meaning that about 40% of the world population has an internet connection today).

The concept of interconnectivity by the internet can be referred to as The Internet of things (IoT), meaning the inter-networking of physical devices, vehicles (also referred to as “connected devices” and “smart devices”), buildings, and other items—embedded with electronics, software, sensors, actuators, and network connectivity that enable these objects to collect and exchange data.

In 1995, at the beginning of the internet age, usage was less than 1%. Since 1993, when usage was essentially zero, the number of people using the internet has increased to about 3.4 billion today (2016).

In addition to the internet, and other computer networks, there are also cellular and other telecommunications networks (e.g., radio, satellite, among others). For the purposes of this discussion, however, and in fulfillment of the dual purposes of clarity and brevity, the plurality of communications networks that exist shall be referred to as cellular networks. According to Quartz Media, LLC, there are almost as many cell-phone subscriptions (6.8 billion) as there are people on this earth (seven billion). In 2013, there were about 96 cell-phone service subscriptions for every 100 people in the world. (See, https://qz.com/179897/more-people-around-the-world-have-cell-phones-than-ever-had-land-lines/) In just the United States, nearly two-thirds of Americans own a smartphone, and 19% of Americans rely to some degree on a smartphone for accessing online services and information and for staying connected to the world around them. (See, http://www.pewinternet.org/2015/04/01/us-smartphone-use-in-2015/).

However, not-withstanding that there are at least two substantive communications networks, in which a significant portion of the population in most industrialist-based nations exist, there has not existed a manner in which to obtain, store, and correlate information regarding individuals that can be used for numerous purposes that uses at least one network of each of the two major different types of networks.

Thus, there are certain problems with the conventional approaches to gather information about individuals, storing that data, and then correlating the same for any one of numerous purposes. Accordingly, it would be desirable to provide for gathering, storing, and correlating data about individuals across a plurality of communications networks.

### SUMMARY

An object of the embodiments is to substantially solve at least the problems and/or disadvantages discussed above, and to provide at least one or more of the advantages described below.

It is therefore a general aspect of the embodiments to provide systems, methods, and modes for gathering, storing, and correlating data about individuals across a plurality of communications networks that will obviate or minimize problems of the type previously described.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

According to a first aspect of the embodiments, a According to a first aspect of the embodiments, a method is provided for correlating data regarding a plurality of subscribers, the method comprising: gathering data from each of the plurality of subscribers regarding a first subject matter via a first communications system; processing the gathered data from each of the subscribers; correlating substantially similar gathered data from each of the subscribers into separate respective correlated data reports; and reporting one or more of the separate respective reports to one or more third parties via a second communications system.

According to the first aspect of the embodiments, the step of gathering comprises: installing a data gathering application for use on a cellular communications device, wherein the data gathering application is adapted to interface with a position tracking application and at least one of a text messaging application and an electronic mail (email) messaging application on the cellular communications device, and wherein the data gathering application is further adapted to acquire and report position and travel information substantially continuously, and wherein, the data gathering application is further adapted to acquire and report purchasing information substantially continuously.

According to the first aspect of the embodiments, the step of gathering further comprises exchanging a first benefit for a first predetermined unit of travel as determined by the position tracking application and data gathering application.

According to the first aspect of the embodiments, the first benefit comprises at least one of a predetermined amount of a digital currency and a predetermined amount of a conventional currency.

According to the first aspect of the embodiments, the data gathering application is further adapted to receive pushed message information to be presented to a user of the cellular communications device

According to the first aspect of the embodiments, substantially similar gathered data comprises at least one of gathered data that was generated at a location of a subscriber that is within a first predetermined geographical area, and purchasing information.

According to the first aspect of the embodiments, the first communications system comprises a cellular network communications system, and the second communications system comprises an internet network communications system.

According to the first aspect of the embodiments, the step of reporting one or more of the separate respective reports comprises auctioning one or more of the respective reports to one or more third parties.

According to the first aspect of the embodiments, the step of auctioning comprises: advertising the auction; and conducting the auction, wherein auctioned material comprises communications information that corresponds to a plurality of subscribers that are included in respective correlated data reports, wherein such communications information has been knowingly provided by the subscribers in exchange for digital currency.

According to a second aspect of the embodiments, a system is provided for correlating data regarding a plurality of subscribers, the system comprising: a data collection agency adapted to gather data from each of the plurality of subscribers regarding a first subject matter via a first communications system; process the gathered data from each of the subscribers; correlate substantially similar gathered data from each of the subscribers into separate respective correlated data reports, and report one or more of the separate respective reports to one or more third parties via a second communications system.

According to the second aspect of the embodiments, the system further comprises a cellular communications device that includes a data gathering application, wherein the data gathering application is adapted to interface with a position tracking application and at least one of a text messaging application and an electronic mail (email) messaging application on the cellular communications device, and wherein the data gathering application is further adapted to acquire and report position and travel information substantially continuously, and wherein, the data gathering application is further adapted to acquire and report purchasing information substantially continuously.

According to the second aspect of the embodiments, the data gathering application is further adapted to receive a communication in which an exchange is made for a first benefit for a first predetermined unit of travel as determined by the position tracking application and data gathering application.

According to the second aspect of the embodiments, the first benefit comprises at least one of a predetermined amount of a digital currency, and a predetermined amount of a conventional currency.

According to the second aspect of the embodiments, the data gathering application is further adapted to receive pushed message information to be presented to a user of the cellular communications device.

According to the second aspect of the embodiments, substantially similar gathered data comprises at least one of gathered data that was generated at a location of a subscriber that is within a first predetermined geographical area, and purchasing information.

According to the second aspect of the embodiments, the first communications system comprises a cellular network communications system, and the second communications system comprises an internet network communications system.

According to the second aspect of the embodiments, the data collection agency is further adapted conduct an auction of one or more of the respective reports to one or more third parties.

According to the second aspect of the embodiments, the data collection agency is further adapted, when conducting the auction, to advertise the auction, and conduct the auction in regard to auctioned material that comprises communications information that corresponds to a plurality of subscribers that are included in respective correlated data reports, wherein such communications information has been knowingly provided by the subscribers in exchange for digital currency.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

FIG. 1 illustrates a flow diagram of the exchange of remuneration, data, goods, and services, and which further includes the transfer of individual purchasing and shopping habits in exchange for compensation according to aspects of the embodiments.

FIG. 2 is a simplified block diagram of a physical environment within which individuals can provide data to a data gathering, storing, and correlating agency according to aspects of the embodiments.

FIG. 3 is a flow diagram of a method for gathering, storing, and correlating data about individuals across a plurality of communications networks according to aspects of the embodiments.

FIG. 4 illustrates a network system within which a system and method for gathering, storing, and correlating data about individuals across a plurality of communications networks can be implemented according to aspects of the embodiments.

FIG. 5 illustrates a data collection agency server suitable for use to implement a method for gathering, storing, and correlating data about individuals across a plurality of communications networks according to aspects of the embodiments.

FIG. 6 illustrates a flow diagram of an auction exchange that incorporates travel and purchase data of subscribers according to aspects of the embodiments.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments can, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The following embodiments are discussed, for simplicity, in regard to the terminology and structure of a computer network such as the internet and usage by subscribers of a webpage. However, the embodiments to be discussed next are not limited to these systems but can be applied to other fields such as sporting events, stock market behavior, the gaming industry, among others.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics can be combined in any suitable manner in one or more embodiments.

Further still, it should be apparent to those of skill in the art that while certain items in the drawing Figures have been denoted “top,” “bottom,” “left side,” right side,” and the like, such spatial indicators are or can be arbitrary, and are done for the purposes of making it easier for the reader to understand and visualize the aspects of the embodiments and are not to be construed in a limiting manner.

According to aspects of the embodiments, the problems described above can be addressed by, for example, systems, methods, and modes for gathering, storing, and correlating data about individuals across a plurality of communications networks. That is, according to aspects of the embodiments, each of a plurality of subscribers can agree to provide purchasing and travel information to a data collection agency that, in exchange for such information, provides a form of compensation that is not currency, but that at some later time can be exchanged for currency. Data collection occurs in at least two phases; a first occurrence when a subscriber accepts push-advertisements (discussed in greater detail below); and when the actual purchase is made after the subscribers travel to various destinations upon which they purchase goods and services using conventional currency; according to aspects of the embodiments, the travel and purchasing information can both be collected, stored and correlated by the data collection agency, and then sold to one or more merchants; in exchange for the collected purchasing data, the merchants provide conventional currency to the data collection agency, a portion of which is attributed to the compensation provided to the subscribers. The merchants can also forward advertisement information to the subscribers using the same mechanism upon which the data collection (among others) originally occurred.

Used throughout the specification are several acronyms, the meanings of which are provided as follows:

| | |
|---|---|
| 3G | Third Generation |
| 4G | Fourth Generation |
| ACM | Alternative Currency Means |
| App | Executable Software Programming Code/Application |
| ASIC | Application Specific Integrated Circuit |
| BIOS | Basic Input-Output System |
| BT | BlueTooth |
| CAT5 | Category 5 Ethernet |
| CC | Conventional Currency |
| CD | Compact Disk |
| CRT | Cathode Ray Tube |
| DCA | Data Collection Agency |
| DVD | Digital Versatile Disk |
| EEPROM | Electrically Erasable Programmable Read Only Memory |
| FD | Flash Drive |
| FDD | Floppy Disk Drive |
| FPGA | Field Programmable Gate Array |
| G/S | Goods/Services |
| GPS | Global Positioning System |
| GUI | Graphical User Interface |
| HDD | Hard Disk Drive |
| HDMI | High Definition Multimedia Interface |
| ISP | Internet Service Provider |
| LCD | Light Commanding Diode |
| LED | Light Emitting Diode |
| LTE | Long Term Evolution |
| MD | Mobile Device |
| MODEM | Modulator/Demodulator |
| NFC | Near Field Communications |
| NW | Network |
| PC | Personal Computer |
| PED | Personal Electronic Device |
| POTS | Plain Old Telephone Service |
| PSA | Public Service Announcement |
| RAM | Random Access Memory |
| ROM | Read-Only Memory |
| RW | Read/Write |
| SIM | Subscriber Identity Module |
| TPD | Travel and Purchase Data |
| USB | Universal Serial Bus |
| UVPROM | Ultra Violet Programmable Read Only Memory |
| VGA | Video Graphics Array |

The following is a list of the elements of the Figures in numerical order:

| | |
|---|---|
| 100 | Transactional Flow Diagram |
| 102 | Data Collection Agency (DCA) |
| 104 | Advertisers |
| 106 | Subscribers |
| 108 | Retailers/Providers of Goods/Services |
| 110 | New Subscribers |
| 112 | Travel and Purchase Data (TPD) |
| 114 | Alternative Currency Means (ACM) |
| 116 | Conventional Currency (CC) |
| 118 | Goods/Services (G/S) |
| 120 | Processed Travel and Purchase Data (Processed TPD) |
| 122 | Advertisements/Messages |
| 124 | Mobile Device (MD) |
| 126 | Travel and Purchase Data (TPD) Application (App) |
| 128 | DCA Server |
| 130 | Travel and Purchase Data (TPD) Collection and Correlation |
| | Application (C&C App) |
| 200 | Physical Environment |
| 124 | Home |
| 204 | Store |
| 206 | Activity Location |
| 208 | Work Location |
| 210 | Gym Facility |
| 212 | School Building |
| 214 | Friend's House |
| 216 | Travel Path |
| 300 | Method for Gathering, Storing, and Correlating Data About |
| | Individuals Across a Plurality of Communications Networks |
| 302- | Steps of Method 300 |
| 312 | |
| 400 | Network System |
| 406 | Internet Service Provider (ISP) |
| 408 | Modulator/Demodulator (Modem) |
| 410 | Wireless Router |
| 412. | Plain Old Telephone Service (POTS) Provider |
| 414 | Cellular Service Provider |
| 418 | Communication Satellites |
| 420 | Cellular Telecommunications Service Tower (Cell Tower) |
| 422 | Internet |
| 424 | Global Positioning System (GPS) Station |
| 426 | Satellite Communication Systems Control Station |
| 428 | GPS Satellite |
| 501 | Shell/Box |
| 502 | Integrated Display/Touch-Screen (laptop/tablet etc.) |
| 504 | Internal Data/Command Bus (Bus) |
| 506 | Processor Internal Memory |
| 508 | Processor(s) |
| 510 | Universal Serial Bus (USB) Port |
| 511 | Ethernet Port |
| 512 | Compact Disk (CD)/Digital Versatile Disk (DVD) Read/Write |
| | (RW) (CD/DVD/RW) Drive |
| 514 | Floppy Diskette Drive (FDD) |
| 516 | Hard Disk Drive (HDD) |
| 518 | Read-Only Memory (ROM) |
| 520 | Random Access Memory (RAM) |
| 522 | Video Graphics Array (VGA) Port or High Definition Multimedia |
| | Interface (HDMI) |
| 524 | External Memory Storage Device |
| 526 | External Display/Touch-Screen |
| 528 | Keyboard |
| 530 | Mouse |
| 532 | Processor Board/PC Internal Memory (Internal Memory) |
| 534 | Flash Drive Memory |
| 536 | CD/DVD Diskettes |
| 538 | Floppy Diskettes |
| 540 | HDMI Cable |
| 542 | Wi-Fi Transceiver |
| 544 | BlueTooth (BT) Transceiver |
| 546 | Near Field Communications (NFC) Transceiver |
| 548 | Third Generation (3G), Fourth Generation (4G), Long Term |
| | Evolution (LTE) (3G/4G/LTE) Transceiver |
| 550 | Communications Satellite/Global Positioning System (Satellite) |
| | Transceiver Device |
| 552 | Antenna |
| 556 | Universal Serial Bus (USB) Cable |
| 558 | Ethernet Cable (CAT5) |
| 560 | Scanner/Printer/Fax Machine |
| 600 | Flow Diagram of Auction Exchange |
| 602 | Merchant (Advertiser 104) |
| 604 | Geographical Location(s) |
| 606 | Auction Exchange (DCA 102) |
| 608 | Communications Information Corresponding to First Subset of |
| | Subscribers 106 |
| 612 | Bid Communications from Merchants 602 to Auction Exchange |
| | 606 |
| 614 | Winning Bid Communication |
| 616 | Push Advertisement Communication |
| 618 | Conventional Currency 116 for Purchase of Goods/Services |
| | Related to Pushed Advertisement Communications 616 (Purchases) |
| 620 | Goods/Services 118 Related to Pushed Advertisement |
| | Communications 616 |
| 622 | Percentage of Purchases 618 plus Winning Bid Cost |

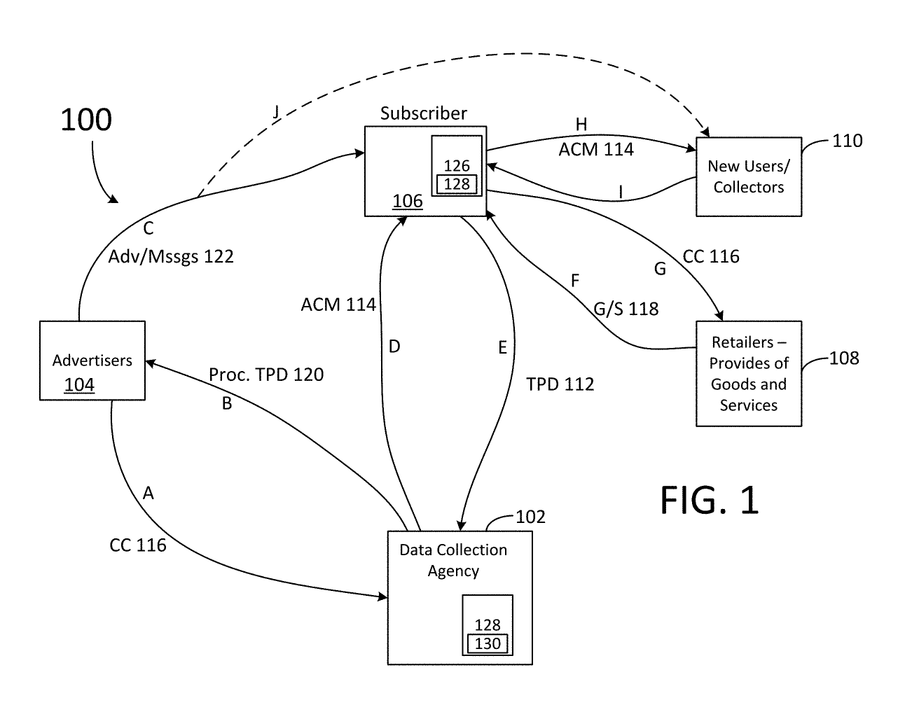

Attention is now directed towards FIG. 1. According to aspects of the embodiments, the diagram of FIG. 1 illustrates flow diagram 100 of the exchange of compensation, goods, services, and creation of alternate currency member (ACM) 114. Flow diagram 100 includes the movement and exchange of data, goods/services (G/S) 118, and compensation (conventional currency (CC) 116) that includes the transfer of individual purchasing and shopping habits in exchange for compensation according to aspects of the embodiments. Data collection agency (DCA) 102 recruits subscribers 106 to participate in the systems and methods of the aspects of the embodiments; that is, according to aspects of the embodiments, in exchange for providing purchasing and travel data (travel and purchase data, or “TPD”) 112 (Arrow E), DCA 102 provides compensation in the form of alternative currency means (ACM) 114 (Arrow D). In recruiting subscribers 106, DCA 102 requests a profile of subscriber 106; according to aspects of the embodiments, subscriber 106 can provide such information as consumption habits (where they shop for food, what types, what their interests and hobbies are, and things of the like); in exchange for such information, subscribers receive pre-negotiated deals and savings' coupons, which are sent directly to MD126 (and received by TPD App 128, once subscriber 106 becomes fully signed-on). DCA 102 further benefits from this aspect of the embodiments in that DCA 102 can receive a fixed, known percentage (albeit a small percentage) of the purchase by subscriber 106, if or when it occurs.

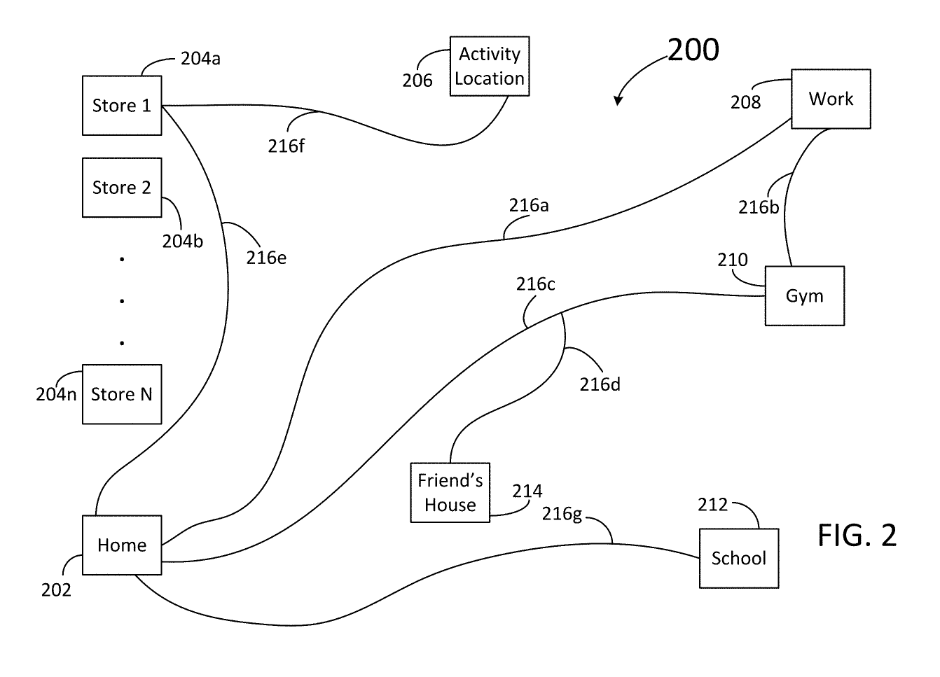

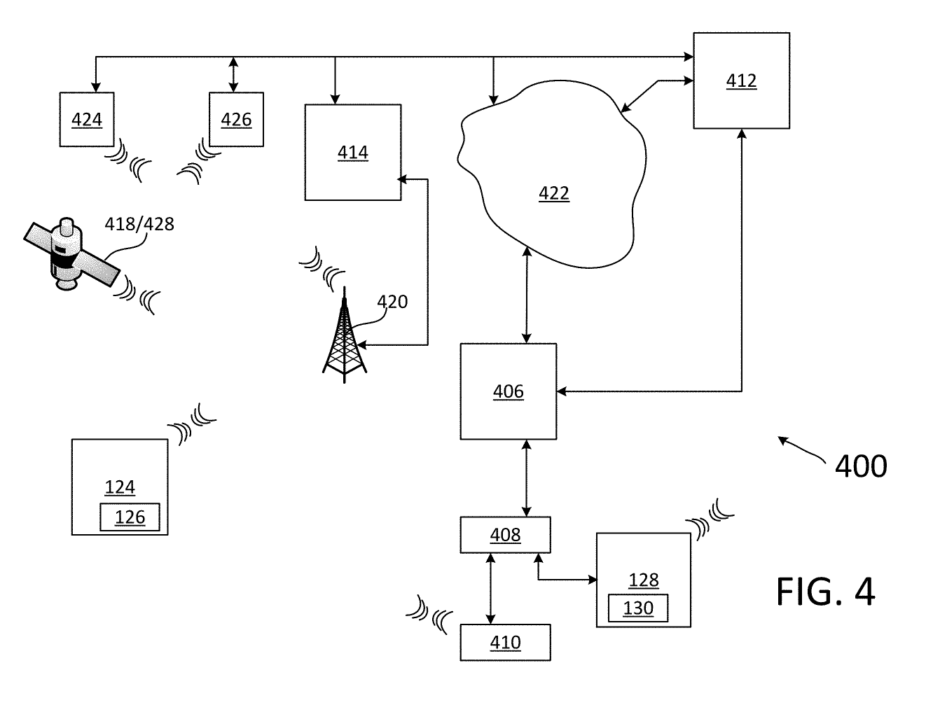

Subscribers 106 agree to download TPD application (TPD App) 128 onto their smart phones, or other personal electronic devices (PEDs; e.g., mobile devices (MD) 126), as described in greater detail below in regard to FIG. 4. TPD App 128 tracks the position and traveling of subscriber 106; as those of skill in the art can appreciate, such data can be used for nefarious purposes; therefore, in accordance with all privacy laws and regulations, appropriate privacy safeguards can be installed. As subscribers 106 travel to and from their daily destinations and home, as described in FIG. 2, below, their purchasing and travel information/data is automatically uploaded to TPD collection and correlation App (C&C App) 130 (described in greater detail below; and located with DCA 102), so that DCA 102 can make use of it in accordance with aspects of the embodiments, as described in greater detail below. As those of skill in the art can appreciate, MD 126 can be used to capture purchase data directly. That is, through the use of such technology as COINSNOBS Wallet, Google Wallet, PayPal, and Apple Pay, among others, subscriber 106 can make a purchase at one or more stores 204 using just their MD 126. Such applications can interface directly with TPD App 126 to report the purchases substantially instantaneously, or periodically. A discussion of the specific procedures of how to use such purchasing technology is not necessary in understanding the aspects of the embodiments, and therefore in fulfillment of the dual purposes of clarity and brevity, such discussion has been omitted. In addition, subscribers 106 can also have their purchases reported indirectly through the acquisition of information of purchases made by credit or debit card from the banks that maintain such debit or credit cards. Further still, in the event of cash purchases, in which no electronic record is maintained, TPD App 126 can query subscriber 106, when it recognizes that subscriber 106 might be at a retail establishment (via use of GPS technology), and then report such purchases as it does travel information. Purchase information can be confirmed by taking a photograph of a cash purchase receipt, which is then also forwarded along with the travel information.

In the ordinary course of their lives, subscribers 106 travel and visit retailers 108, among other locations (shown in FIG. 2) and, in exchange for conventional currency (CC) 116 (Arrow G), purchase and obtain G/S 118, as shown by Arrow F. Such travel and purchase activity, or TPD 112, is recorded by subscriber's MD 126 and TPD App 128 and is then forwarded to DCA 102, server 128, and C&C App 130, according to aspects of the embodiments, through one or both of a cellular network and the internet.

According to aspects of the embodiments, there can be several groups of users of system 100 and method 300 (described in greater detail below) that can accumulate compensation/credits (or “snobs” as defined below) based on their own or others' activities. A first group of users/participants can be referred to as tier 1, or active movers (or subscribers 106). Tier 1 participants (subscribers 106) are active movers, or live people that themselves “move” from point A to point B. According to further aspects of the embodiments, tier 1 participants can include pilots, truckers, commercial shipping drivers (such as, but not limited to UPS, FedEx, and DHL drivers, among others), taxi and limousine drivers, among other surface transport drivers (e.g., Uber customers and drivers), airline passengers, daily commuters, as well as any person that drives a car, rides a bike or motorcycle, or virtually any other type of transportation. As those of skill in the art can appreciate, such a listing of subscribers 106 is not to be taken in a limiting sense, but merely provided as instructive examples.

According to aspects of the embodiments, it is preferred that Tier 1 participants have their cell-phone physically within their possession for GPS tracking. Although the use of virtual subscriber identity module (SIM) cards is not yet widespread, the use of such modules within cell-phones can be prohibited in the subscriber agreement, although such prohibition should not be taken in a limiting manner, in that in different aspects of the embodiments, such virtual SIMs can be allowed.

According to aspects of the embodiments, a second group of participants that can accumulate credits or snobs are tier 2 participants, or initiator movers. An initiator mover can be defined as the person or entity that causes movement of physical objects/things that move from point A to point B; an initiator mover can include real people, such as tier 1 participants. Non-limiting examples of how an initiator mover can come into existence, is any time subscriber 106 uses e-commerce service provided by Ebay, Amazon, Overstock.com, Walmart.com, among the virtually limitless vendors that sell goods through the internet. Further, initiator movers can come into existence through the use of purchasing items from printed magazines, or through the use of such entities as broadcast vendors such as QVC, the Home Shopping Network (HSN), among others. Further non-limiting examples of vendors that can cause an initiator mover to come into existence include users of Expedia, Kayak, Travelocity, Hotels.com, Bookings.com, among many others.

The distance moved by these physical objects and things, generally through the mail, or shipping companies, can then be credited to the person (tier 1 participant) that ordered the physical object/thing. Such shipping information can be readily tracked obtained from the shipping companies' webpages, or other electronic means, as well as being reporting by the tier 1 participant/subscriber 106. According to further aspects of the embodiments, such shipping information can be applied in the same or substantially similar manner for digital purchases such as downloadable software, digital books, music, among other types of digital data. For example, for each vendor the distance information can be the true distance from the corporate headquarters, or some portion thereof, in view of the fact that no physical article actually moved along physical channels of commerce.

According to further aspects of the embodiments, a third group of participants that can accumulate credits or snobs are tier 3 participants, or enabler movers. Enabler movers can be defined as the “large complex distributors with regional/national warehouses” whose job it to move/distribute, by way of air and/or surface transportation of all kinds (rail, boat, automotive, among others) any type of goods to subscribers 106, and service and/or consumption centers such as hotels, restaurants, cafes, bars, airplanes, among other types. Non-limiting examples of enabler movers can include carriers that move perishables and nonperishable specifically catering to the needs of the hospitality and food service industry. Several entities that exist that provide such services include Sysco, US Foods, and regional food distributors, among others.

According to aspects of the embodiments, DCA 102 enters into agreements with one or more advertisers 104, as shown by Arrows A and B. Advertisers 104 can include one or more of retailers, providers of goods and services, advertisement agencies, among other entities that can make use of TPD 112. However, in fulfillment of the dual purposes of clarity and brevity, reference shall only be made to advertisers 104. Furthermore, according to aspects of the embodiments, what is provided to the one or more advertisers 104 is not “raw” or unprocessed/unfiltered TPD 112, but processed TPD 120. That is, DCA 102 receives all of the incoming TPD 112 from the plurality of subscribers 106, and processes or correlates it into a meaningful set of data (processed TPD 120) that substantially maximizes its use for the purposes of the systems and methods according to aspects of the embodiments.

For example, such processed TPD 120 would not include the name(s) of subscribers 106, nor their exact address or any other identifying information, but can be segregated according to products or services. Thus, by way of non-limiting example only, because a number of subscribers 106 might show purchases at a specific gas station, the processed TPD 120 can include a sub-set of subscribers 106 that purchased gas and/or other products at that gas station, and to those subscribers 106 can receive directed advertisements 122 for that particular brand/location of gasoline and other products/services available at that one or more gas stations. Subscribers 106 can, as those of skill in the art can now appreciate, show up in more than one segregated subset of subscribers 106. In exchange for such processed TPD 120 (Arrow B), advertisers pay in the form of CC 116 (Arrow A).

According to further aspects of the embodiments, TPD App 128 can also be located on a website of one or more of advertisers 104 such that when potential purchasers land there in their use of the internet, the potential purchaser has the opportunity to become a subscriber 106 according to aspects of the embodiments. Such cross-marketing opportunities provide for further compensation of mutual benefit, according to aspects of the embodiments.

After advertisers 104 have received processed TPD 120 in exchange for CC 116, advertisers 104 can then forward advertisements/messages 122 to subscribers 106 (Arrow C). Subscribers 106 then have the option to open, and/or use advertisements 122. Such communications from advertisers 104 to subscribers 1056 can be in the form of “true” advertisements, e.g., “Product A is available for purchase at location B.” However, advertisements 122 can encompass additional communications according to aspects of the embodiments, such as coupons, messages, public service announcements (PSA) and the like. Consequently, advertisers 104 includes not only “for-profit” organizations, but also not-for-profit organizations, government institutions, and the like, among other types. As described above, DCA 102 compensates subscribers 106 in the form of ACM 114. ACM 114 can also be referred to, as a “Snob.”

According to aspects of the embodiments, ACM 114 is created or produced in electronic form, and is therefore encrypted and protected from electronic intrusion and replication using Blockchain technology, among other encryption types. As such, its value is determined solely by both extrinsic value input by DCA 102, and as a commodity to be exchanged according to principles of the free market and free trade. According to aspects of the embodiments, one manner of injecting value into ACM 114 is the value of advertisements and offers provided by advertisers 104; a holder of ACM 114 can be entitled to receive and redeem such advertisement and offers. In this manner, advertisers 104 can forward advertisements 122 to new subscribers 110, as represented by Arrows C and J. Subscribers 106 can exchange ACMs 114 with new subscribers 110, as represented by Arrows H and I, in exchange for CC 116, or other goods/services. According to aspects of the embodiments, ACMs 114 held or created by different subscribers 106 can have different inherent values associated with them. For example, suppose there are two subscribers 106a,b, one whose gross income is in the many hundreds of thousands of dollars and another whose gross income is about $50K; both travel the same amount of miles, and shop the same number of times, but shop at much different types of stores. ACM 114a of the higher income person could be inherently worth more than that of the lower income person.

Referring now to FIG. 2, there is shown a simplified block diagram of physical environment 200 within which individuals can provide TPD 112 data to DCA 102 according to aspects of the embodiments. As subscribers 106 travel from home 202 to work 208, via path 216a, they will generally commute through cities and town in which they live and/or work, and there will generally many different types of goods/services providers that subscribers 106 can purchase such goods/services. Within physical environment 200 there can be stores 204a-n, one or more activity locations 206, friend's houses 214, schools 212, gyms 210, and work-places 208, among other types of locations.

For example, perhaps after leaving work 208, subscriber 106a travels to gym 210 via path 216b, then can return home via path 216c, or go to a friend's house 214 via path 214. On a different day, subscriber 106 may instead head to store 1 204a and make a purchase; all of this travel and purchasing activity is captured by TPD App 128 on mobile device 126 of subscriber 106a.

According to aspects of the embodiments, some or all such travel by each of the plurality of subscribers 106a-n can count towards a compensation scheme in which the subscribers 106a-n receive ACM 114. One such non-limiting example can be that for each mile traveled, each subscriber 106 receives one Snob, e.g., a unit of currency of ACM 114. Such a reward system can entice more subscribers 106 to participate in accordance with the systems and methods of the aspects of the embodiments.

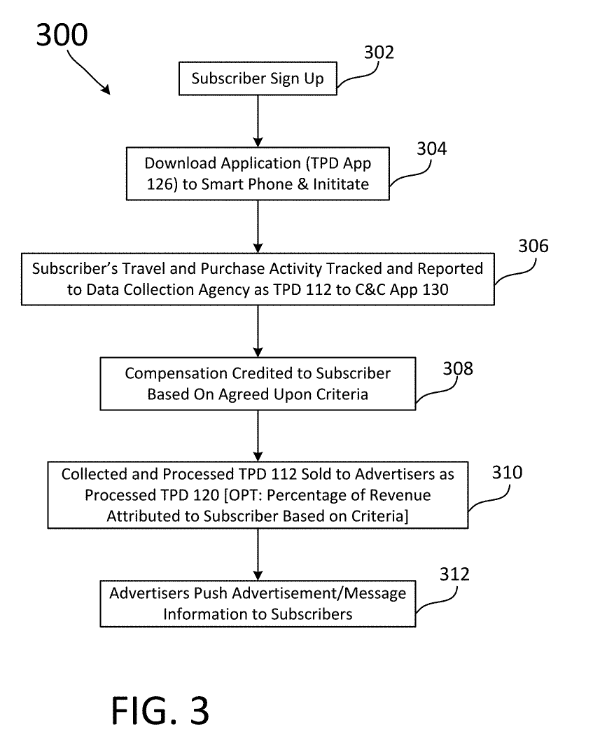

FIG. 3 is a flow diagram of method 300 for gathering, storing, and correlating data about individuals across a plurality of communications networks (method 300) according to aspects of the embodiments. Method 300 begins with step 302 in which DCA 102 registers subscribers 106 to enroll in the data tracking, storing, and correlating system and method according to aspects of the embodiments. As part of the acceptance of the offer, subscribers 106 in method step 304 download TPD App 126 onto their mobile device 124. TPD App 126 communicates with C&C App 130 located in DCA server 128, according to aspects of the embodiments, through network 400, as shown in FIG. 4, and described below.

In method step 306, as shown in FIG. 3, subscribers 106 travel to work, school, after work activities, stores, church, and a myriad other places, making purchases, and acquiring goods and services, among other activities. Each purchase and travel activity is recorded by TPD App 126 and eventually reported back to C&C App 130 located on server 128; as those of skill in the art can appreciate, server 128 can be one or more servers, co-located in one location, or located at multiple locations for the purpose of security. DCA 102 can collect and correlate TPD 112 substantially continuously, or, as is more often the case, periodically, such as at the end of the day, or during the evening, and reports can be run to generate processed TPD 120, as described above.

In method step 308, DCA 102 issues a credit in the form of ACM 114 to subscriber 106. Such credits can be issued substantially regularly, such as at the end of each week or month, or after each purchase and/or travel event, in accordance with their individual agreement. By way of non-limiting example, a suggested “exchange” rate for Snobs to TPD 112, is one Snob for each mile traveled, with bonus Snobs for certain levels of purchases (e.g., 5 Snobs for each additional $10 purchased). According to further aspects of the embodiments, with certain vendors, and under certain conditions, Snobs can be exchanged for items of value, at some agreed upon rate of exchange (e.g., one Snob=$1.00). Such use of Snobs can be accomplished through the use of QR codes. QR codes are relatively small blocks that are usually black and white that can be used by manufacturers to convey information such as location and date of manufacture, model or version information of the product being sold, and many other different types of information that can be important to a purchaser, retailer, or vendor, among other entities. The QR codes can be read by optical scanners, in a substantially similar manner as those of the Universal Product Code (UPC) bar codes, the use of which is virtually ubiquitous in today's retail establishment.

According to further aspects of the embodiments, another form of TPD 112 comprises the acceptance of pushed advertisement data. For example, as is well known by now of virtually everyone with a “smart phone” often times advertisements appear when searches are made, or when certain programs or applications are used on the smart phone. According to aspects of the embodiments, subscribers 106 can accumulate Snobs when they click on the advertisement and capture it for later use. For example, through the use of TPD App 126 when a certain advertisement is pushed to subscriber 106, TPD App 126 will cause an “ACCEPT” button to appear, and if the particular subscriber 106 accepts the pushed advertisement, one or more Snobs can be credited for the acceptance of the pushed advertisement, and/or one or more Snobs can be credited to the particular subscriber for the use of the same pushed and accepted advertisement. Such credits can be 1:1; that is, one Snob for each dollar spent, or some other exchange rate according to various aspects of the embodiments. According to still further aspects of the embodiments, electronic wallets (eWallets) can be generated that contain or hold the snobs credited to each particular subscriber 106.

In method step 310, DCA 102 sells collected and processed TPD 112 as processed TPD 120 to one or more advertisers 104. As those of skill in the art can appreciate, the term “advertisers” 104 is not meant to be, and should not be taken, as representing only advertisement agencies.

That is, the term advertisers 104 can refer to, in a more general sense, practically any organization, commercial or otherwise, that is interested in reaching an intended targeted “audience” that might be more receptive of a message/offer from that organization based on their past purchase(s) and/or travel habits (which can also include “non-purchasing” events such as visits to activity centers, or recreational activities, and the like).

According to aspects of the embodiments, sales can occur in at least two ways. The first is through the process of an auction. In the auction process, categories or “specifications” of spending habits are created, and the respective subscribers' communication information (e.g., cell phone numbers and/or email addresses) are collected together. An opening bid is prepared by the auction house (i.e., the conductor of the auction) and various advertisers 104 can then bid on the blocks of subscribers 104; ostensibly, the higher the spending habits in the markets of interest would drive the price of the blocks of subscribers upwards, in a substantially similar manner to that of shares of stock of a company that exhibits growth and/or increased dividends would drive the price of its stock upwards. Such auctions can be conducted completely or partially electronically, or, in some cases, a physical presence of traders can be required.

According to still further aspects of the embodiments, certain conditions can be applied to the auction; for example, once a bidder has won the rights to a block of communications information, there can be a time limit imposed within which the winning bidder must communicate with the subscribers. If no communication is made within the proscribed time limit, then the block of subscriber information is locked and unavailable; a new auction can then be held with the same block of communications information.

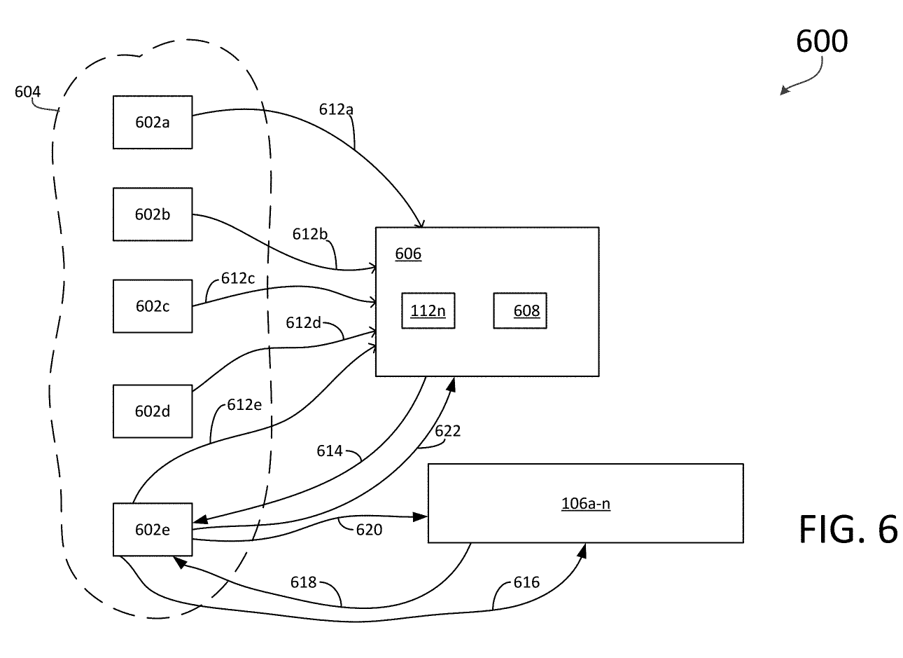

FIG. 6 illustrates flow diagram 600 of an auction exchange that incorporates TPD 112 of subscribers 106 according to aspects of the embodiments. In the auction exchange illustrated in FIG. 6, there are numerous merchants 602a-n (these can also be advertisers 104; though, for purposes of this portion of the discuss, the term “merchants 602” will be used) that provide bid communications 612a-e to auction exchange 606 (which can also be referred to as DCA 102; though, for purposes of this portion of the discussion the term “auction exchange 606 will be used).

Merchants are alerted/invited through direct emails to join a specific auction based on their field of business and target audience. Bid communications 612a-e contain bids in CC 116 for the communications information 608 for selected groups of subscribers 106 that have desired TPD 112; such TPD 112n is available as part of the information that is available for merchants 602 to inspect, along with the number of subscribers 106, and their respective geographical locations 604, as the bid-upon-item. Thus, if the number of subscribers 106, their respective geographical locations, and “quality” of TPD 112 (collectively referred to as the “auction subscriber information”) is enticing to the respective merchant 602, that merchant will make a corresponding bid based on their estimated market value of that auction subscriber information. For example if the auction subscriber information indicated ten thousand subscribers in the Washington D.C. metro area, whose purchases and travel data indicated a significant amount of discretionary spending, then a respective merchant 602 of high quality goods/services might see a significant opportunity (e.g., luxury automobiles), and spend a lot more on a bid, than a merchant 602 that does not provide high quality goods/services.

Bid communications 612a-e are received and processed by auction exchange 606 according to the agreed upon auction rules. Once a winning bid is selected, winning bid communication 612 is sent to the bid winner, in this case merchant 602e. In addition, one or more non-winning bid communications can be sent to the non-winners. As discussed above, the winner of the auction can have an optional time constraint imposed within which to push advertisement communications 616 to subscribers 106a-n based on communications information 608 that contains the cell phone numbers of the subscribers.

Subscribers 106a-n can then decide to act on the advertisements or not, and if they do, then a purchase is made with convention currency via transaction 618, and goods/services are provided via transaction 620; in transaction 622, a percentage of the purchase price can be transferred from winning merchant 602e, along with the winning bad amount, to auction exchange 606.

An optional step, or an optional component of step 310 can be the passing on of a percentage of the revenue received from advertisers 104 to subscribers 106 by adding real value (in the form of actual currency) to ACM 114, or by passing ACM 114 to the respective subscriber 106.

In method step 312, advertisers 104 make use of processed TPD 120 and push advertisements and/or non-commercial messages to one or more of subscribers 106 on their MDs 124 via TPD App 126. Thus, TPD App 126 operates as both a collector and transmitter of information to DCA server 128 and C&C App 130, but also as a receiver of messages and communications form DCA server 128 and C&C App 130. For example, as briefly described above, such non-commercial messages can be “public service announcements,” or fund-raising announcements, and the like).

What has been described thus far, according to an aspect of the embodiments, is but one implementation of systems, methods, and modes for gathering, storing, and correlating data about individuals across a plurality of communications networks when implemented in the form of a remunerative system that engages one or more subscribers 102, collected their TPD 112 in exchange for Snobs, or other remuneration, and then processes and sells, or sells and auctions off that processed information, processed TPD 120, to one or more advertisers 104.

Such is but one implementation of systems, methods, and modes for gathering, storing, and correlating data about individuals across a plurality of communications networks; such collection of data can be more generally implemented to acquire different types of data such as medical study data, or physical access data; there, instead of money or alternate forms of currency being exchanged, knowledge or information can be the currency used instead. Thus, the aspects of the embodiments are not meant to be, and as those of skill in the art can now appreciate, in no manner should they so be construed to be, limited to only or purely financial arrangements or schemes that involve money or are related to business methods and practices. Furthermore, as can now be appreciated by those of skill in the art, the aspects of the embodiments address the technical problem of acquiring data according to a first paradigm of a first communications system, and transposing it—the collected data—in accordance with a second paradigm of a second communications system. Such collection, first processing, then transmission, is not technically feasible in the large scale manner as envisioned by the aspects of the embodiments without regard to the use of the first and second communications systems.

As those of skill in the art can appreciate, the use of “smart-phones” is predicated, at least in part, on the ability to interconnect with the internet; in addition, many cell phones have installed mapping functions that are either directly obtained from the global positioning system (GPS), or provided by their cellular service providers through use of locating mapping techniques. By providing both such functions, a smart cell phone can be used by subscribes 106 with downloaded TPD App 126 to provide location and travel data, and obtain text messages and/or electronic mail through the internet connectivity provided by the cellular carriers. In this manner, and in conformance with their subscription agreement, subscribers 106 can provide data, and receive notifications and communications about goods/services being offered for sale, among other types of messages.

FIG. 4 illustrates network system 400 within which systems, methods, and modes for gathering, storing, and correlating data about individuals across a plurality of communications networks can be implemented according to aspects of the embodiments. Much of the network system infrastructure shown in FIG. 4 is or should be known to those of skill in the art, so, in fulfillment of the dual purposes of clarity and brevity, a detailed discussion thereof shall be omitted.

According to an embodiment, subscriber 106 of the above described system and method can have TPD App 126 stored and operating on their mobile device 124; mobile devices 124 can include, but are not limited to, so-called smart phones, tablets, personal digital assistants, notebook and laptop computers, and essentially any device that can access the internet and/or cellular phone service or can facilitate transfer of the same type of data in either a wired or wireless manner. For purposes of this discussion, subscriber 106 shall be discussed as using only mobile device 124, i.e., a smartphone, though such discussion should be understood to be in a non-limiting manner in view of the discussion above about the other types of devices that can access, use, and provide such information.

In FIG. 4, subscriber 106 has mobile device 124, which can access cellular service provider 414, either through a wireless connection (cellular tower 420) or via a wireless/wired interconnection (a “Wi-Fi” system that comprises, e.g., modulator/demodulator (modem) 408, wireless router 410, personal computer (PC)/server (DCA server) 128, internet service provider (ISP) 406, and internet 422). Further, mobile device 124 can include near field communication (NFC), “Wi-Fi,” and Bluetooth (BT) communications capabilities as well, all of which are known to those of skill in the art. To that end, network system 400 further includes, as many homes (and businesses) do, one or more PCs/servers. However, in the case of subscriber 106, the home/work PC is not shown; in general, while subscribers 106 can access internet 422 through the various devices shown in FIG. 4, in general and in accordance with aspects of the embodiments, TPD App 126 is designed to collect and transmit TPD 112 to C&C App 130 through the user of the subscriber's wireless/internet connectivity, though, in some cases, access can be made through wireless modems/routers and home/business PCs. DCA server 128, which is used by DCA 102, can be connected to wireless router 410 via a wired connection (e.g., modem 408) or via a wireless connection (e.g., Bluetooth). Modem 408 can be connected to ISP 406 to provide internet based communications in the appropriate format to end subscribers (e.g., DCA server 128), and which takes signals from the end subscribers and forwards them to ISP 406. Such communication pathways are well known and understand by those of skill in the art, and a further detailed discussion thereof is therefore unnecessary.

Mobile device 124 can also access global positioning system (GPS) satellite 428, which is controlled by GPS station 424, to obtain positioning information (which can be useful for different aspects of the embodiments), or mobile device 124 can obtain positioning information via cellular service provider 414 using cell tower(s) 420 according to one or more well-known methods of position determination. Some mobile devices 124 can also access communication satellites 418 and their respective satellite communication systems control stations 426 (the satellite in FIG. 4 is shown common to both communications and GPS functions) for near-universal communications capabilities, albeit at a much higher cost than convention “terrestrial” cellular services. Mobile device 124 can also obtain positioning information when near or internal to a building (or arena/stadium) through the use of one or more of NFC/BT devices, the details of which are known to those of skill in the art. FIG. 4 also illustrates other components of network system 400 such as plain old telephone service (POTS) provider 412.

According to further aspects of the embodiments, and as described above, network system 400 also contains DCA server 128 that includes C&C App 130, wherein one or more processors, using known and understood technology, such as memory, data and instruction buses, and other electronic devices, can store and implement code that can implement the system and method for gathering, storing, and correlating data about individuals across a plurality of communications networks according to an embodiment.

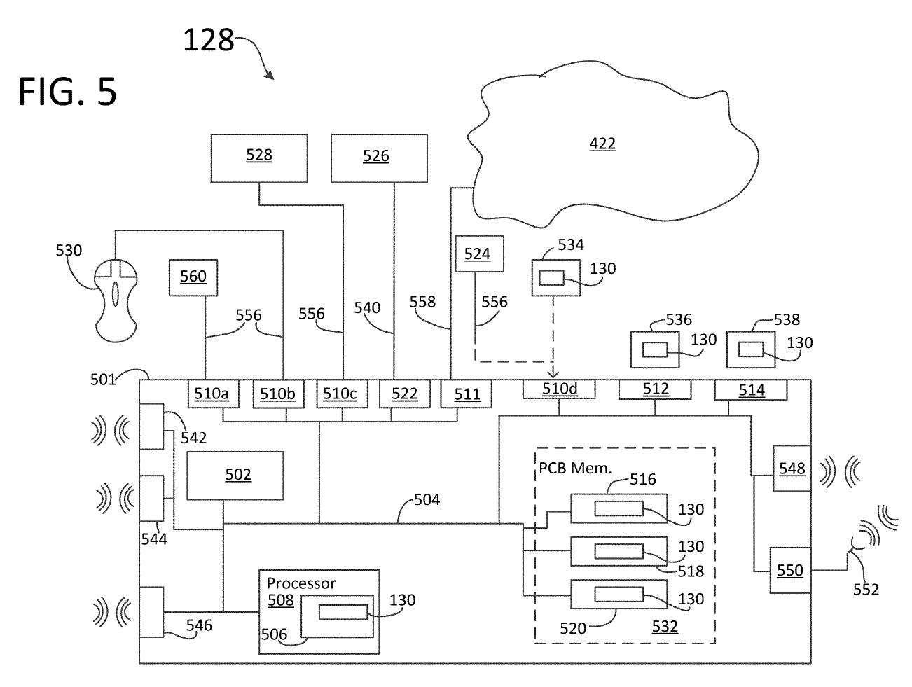

FIG. 5 illustrates DCA server 128 suitable for use to implement method 300 for gathering, storing, and correlating data about individuals across a plurality of communications networks according to aspects of the embodiments. DCA server 128 includes, among other items, shell/box 501, internal data/command bus (bus) 504, processor(s) 508 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 510, compact disk (CD)/digital versatile disk (DVD) read/write (R/W) drive 512, floppy diskette drive 514 (though less used currently, many servers still include this device), and data storage unit 532. According to further aspects of the embodiments, a controller can be used in place or, or in conjunction with processor 508, wherein the controller can include one or more hardware components designed and/or fabricated to replicate the functionality of processor 508. According to still further aspects of the embodiments, processor 508 and a controller can be used interchangeably or in combination to perform the processing functions described herein.

Data storage unit 532 itself can comprise hard disk drive (HDD) 516 (these can include conventional magnetic storage media, but, as is becoming increasingly more prevalent, can include flash drive or solid-state type mass storage devices 534, among other types), read-only memory (ROM) device(s) 518 (these can include electrically erasable (EE) programmable ROM (EEPROM) devices, ultra-violet erasable PROM devices (UVPROMs), among other types), and random access memory (RAM) devices 520. Usable with USB port 510 is flash drive (FD) device 534, and usable with CD/DVD R/W device 512 are CD/DVD disks 536 (which can be both read and write-able). Usable with floppy diskette drive device 514 are floppy diskettes 538. Each of the memory storage devices, or the memory storage media (516, 518, 520, 534, 536, and 538, among other types), can contain parts or components, or in its entirety, executable software programming code or application (application, or “App”) C&C App 130, which can implement part or all of the portions of method 300 described herein. Further, processor 508 itself can contain one or different types of memory storage devices (most probably, but not in a limiting manner, RAM memory storage media 520) that can store all or some of the components of C&C App 130.

In addition to the above described components, DCA server 128 also comprises keyboard 528, display 526, and mouse 530. All of these components are known to those of ordinary skill in the art, and this description includes all known and future variants of these types of devices. Display 526 can be any type of known display or presentation screen, such as liquid crystal displays (LCDs), light emitting diode displays (LEDs), plasma displays, cathode ray tubes (CRTs), among others. DCA server 128 can include one or more user interface mechanisms such as a mouse, keyboard, microphone, touch pad, touch screen, voice-recognition system, among other inter-active inter-communicative devices. Components 528, 530, 560, among others, can interface with DCA server 128 via USB port 510, and display 526 can interface with DCA server 128 via HDMI cable 540 at HDMI 522. Other types of communications ports, and other types of communications means, presently known or further developed, can also be used.

DCA server 128 can further include communications satellite/global positioning system (satellite) transceiver device 550 to which is electrically connected at least one antenna 552 (according to an embodiment, there can be at least one GPS receive-only antenna, and at least one separate satellite bi-directional communications antenna). DCA server 128 can access internet (or other network) 422, either through a hard wired connection, via Ethernet port 511 directly, or wirelessly via Wi-Fi transceiver 542, 3G/4G transceiver 548 and/or satellite transceiver device 550 (and their respective antennas, including satellite antenna 552) according to aspects of the embodiments. DCA server 128 can also be part of a larger network configuration as in a global area network (GAN) (e.g., internet 422), which ultimately allows connection to various landlines.

According to further aspects of the embodiments, a user console (though not shown) can be included that provides a means for personnel to enter commands and configuration into DCA server 128 (e.g., via a keyboard, buttons, switches, touch screen and/or joy stick). Display device 526 can be used to show visual representations of acquired data, and the status of applications that can be running, among other things.

Bus 504 provides a data/command pathway for items such as: the transfer and storage of data/commands between processor 508, Wi-Fi transceiver 542, BT transceiver 544, NFC transceiver 546, internal display 502, HDMI 522, USB port 510, CD/DVD drive 512, floppy diskette drive 514, memory 532, 3G/4G transceiver 548 and satellite transceiver device 550. Through bus 504, data can be accessed that is stored in data storage unit memory 532. Processor 508 can send information for visual display to display 526, and the user can send commands to system operating programs/software/Apps that might reside in processor 508.

DCA server 128, and either memory 506 or memory 532, can be used to implement method 300 for gathering, storing, and correlating data about individuals across a plurality of communications networks according to aspects of the embodiments. Hardware, firmware, software or a combination thereof can be used to perform the various steps and operations described herein. According to an embodiment, C&C App 130 for carrying out the above discussed steps can be stored and distributed on multi-media storage devices such as devices 516, 518, 520, 534, 536 and/or 538 (described above) or other form of media capable of portably storing information, and storage media 534, 536 and/or 538 can be inserted into, and read by, devices such as USB port 510, CD-ROM drive 512, and disk drives 514, 516, among other types of software storage devices.

As also will be appreciated by one skilled in the art, some of the functional aspects of the embodiments can be embodied in mobile device 124, while other functional aspects of the embodiments can be embodied on DCA server 128. Accordingly, the embodiments can take the form of an entirely hardware embodiment or an embodiment combining hardware and software aspects. Further, the embodiments can take the form of a non-transitory computer program product stored on a computer-readable storage medium having computer-readable instructions embodied in the medium. Any suitable computer-readable medium can be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, DVD or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or nonvolatile memory such as ROM and/or RAM. A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable, volatile/nonvolatile, and transitory/non-transitory computer storage media. For example, the processor can access a hard disk drive that reads from or writes to non-removable, nonvolatile, and non-transitory magnetic media, a magnetic disk drive that reads from or writes to a removable, nonvolatile, and non-transitory magnetic disk, and/or an optical disk drive that reads from or writes to a removable, nonvolatile, and non-transitory optical disk, such as a CD-ROM or other optical media. Other removable/non-removable, volatile/nonvolatile, and non-transitory computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include ROM, RAM, CD-ROMs, and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

According to further aspects of the embodiments, network system 400 also contains DCA server 128, wherein one or more processors, using known and understood technology, such as memory, data and instruction buses, and other electronic devices, can store and implement code that can implement the system and method 300 for gathering, storing, and correlating data about individuals across a plurality of communications networks according to aspects of the embodiments.

As described above, an encoding process is discussed in reference to FIG. 3. The encoding process is not meant to limit the aspects of the embodiments, or to suggest that the aspects of the embodiments should be implemented following the encoding process. The purpose of the encoding process described herein is to facilitate the understanding of one or more aspects of the embodiments and to provide the reader with one or many possible implementations of the processed discussed herein. FIG. 3 illustrates a flowchart of various steps performed during the encoding process. The steps of FIG. 3 are not intended to completely describe the encoding process but only to illustrate some of the aspects discussed above.

The disclosed embodiments provide a source array, computer software, and a method 300 for gathering, storing, and correlating data about individuals across a plurality of communications networks. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments can be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and can include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

We claim:

1. A method for correlating data regarding a plurality of subscribers, comprising:
gathering data from each of the plurality of subscribers regarding a first subject matter via a first communications system;
processing the gathered data from each of the subscribers;
correlating substantially similar gathered data from each of the subscribers into separate respective correlated data reports; and
reporting one or more of the separate respective reports to one or more third parties via a second communications system.

2. The method according to claim 1, wherein the step of gathering comprises:
installing a data gathering application for use on a cellular communications device, wherein
the data gathering application is adapted to interface with a position tracking application and at least one of a text messaging application and an electronic mail (email) messaging application on the cellular communications device, and wherein
the data gathering application is further adapted to acquire and report position and travel information substantially continuously, and wherein,
the data gathering application is further adapted to acquire and report purchasing information substantially continuously.

3. The method according to claim 2, wherein the step of gathering further comprises:
exchanging a first benefit for a first predetermined unit of travel as determined by the position tracking application and data gathering application.

4. The method according to claim 3, wherein the first benefit comprises:
at least one of a predetermined amount of a digital currency and a predetermined amount of a conventional currency.

5. The method according to claim 2, wherein
the data gathering application is further adapted to receive pushed message information to be presented to a user of the cellular communications device.

6. The method according to claim 1, wherein substantially similar gathered data comprises:
at least one of gathered data that was generated at a location of a subscriber that is within a first predetermined geographical area, and purchasing information.

7. The method according to claim 1, wherein the first communications system comprises:
a cellular network communications system.

8. The method according to claim 1, wherein the second communications system comprises:
an internet network communications system.

9. The method according to claim 1, wherein the step of reporting one or more of the separate respective reports comprises:
auctioning one or more of the respective reports to one or more third parties.

10. The method according to claim 9, wherein the step of auctioning comprises:
advertising the auction; and
conducting the auction, wherein auctioned material comprises
communications information that corresponds to a plurality of subscribers that are included in respective correlated data reports, wherein such communications information has been knowingly provided by the subscribers in exchange for digital currency.

11. A system for correlating data regarding a plurality of subscribers, comprising:
a data collection agency adapted to
gather data from each of the plurality of subscribers regarding a first subject matter via a first communications system;
process the gathered data from each of the subscribers;
correlate substantially similar gathered data from each of the subscribers into separate respective correlated data reports, and
report one or more of the separate respective reports to one or more third parties via a second communications system.

12. The system according to claim 11, further comprising:
a cellular communications device that includes a data gathering application, wherein
the data gathering application is adapted to interface with a position tracking application and at least one of a text messaging application and an electronic mail (email) messaging application on the cellular communications device, and wherein
the data gathering application is further adapted to acquire and report position and travel information substantially continuously, and wherein,
the data gathering application is further adapted to acquire and report purchasing information substantially continuously.

13. The system according to claim 12, wherein
the data gathering application is further adapted to receive a communication in which an exchange is made for a first benefit for a first predetermined unit of travel as determined by the position tracking application and data gathering application.

14. The system according to claim 13, wherein the first benefit comprises:
at least one of a predetermined amount of a digital currency, and a predetermined amount of a conventional currency.

15. The system according to claim 12, wherein
the data gathering application is further adapted to receive pushed message information to be presented to a user of the cellular communications device.

16. The system according to claim 11, wherein substantially similar gathered data comprises:
at least one of gathered data that was generated at a location of a subscriber that is within a first predetermined geographical area, and purchasing information.

17. The system according to claim 11, wherein the first communications system comprises:
a cellular network communications system.

18. The system according to claim 11, wherein the second communications system comprises:
an internet network communications system.

19. The system according to claim 11, wherein
the data collection agency is further adapted conduct an auction of one or more of the respective reports to one or more third parties.

20. The system according to claim 19, wherein
the data collection agency is further adapted, when conducting the auction, to
advertise the auction, and
conduct the auction in regard to auctioned material that comprises
communications information that corresponds to a plurality of subscribers that are included in respective correlated data reports, wherein such communications information has been knowingly provided by the subscribers in exchange for digital currency.
